(19) United States
(12) Patent Application Publication
(10) Pub. No.: US 2017/0357656 A1
(43) Pub. Date: Dec. 14, 2017

(54) REDUCING FILE SYSTEM JOURNALING WRITES

(71) Applicant: Hewlett Packard Enterprise Development LP, Houston, TX (US)

(72) Inventor: Matt Gates, Houston, TX (US)

(21) Appl. No.: 15/176,182

(22) Filed: Jun. 8, 2016

(51) Int. Cl. G06F 17/30; G06F 3/06

(52) U.S. Cl. CPC G06F 17/30082; G06F 3/0653; G06F 3/0659; G06F 17/30191; G06F 3/0665; G06F 3/064; G06F 3/0673; G06F 3/0644; G06F 3/0656; G06F 3/061

(57) ABSTRACT

In various examples, a device may include a memory, and a processor to execute an operating system comprising a journaling file system. The processor may: determine, based on a page of a journaling file system and a journal entry of the file system associated with a first pending write, whether a second write is pending for the page, wherein the second pending write will occur after the first pending write. Responsive to determining that the second pending write will occur after the first pending write, the processor may skip execution the first pending write.

### BACKGROUND

A computing device may execute an operating system. The operating system may read and write data stored using a journaling file system.

### BRIEF DESCRIPTION OF THE DRAWINGS

Certain examples are described in the following detailed description and in reference to the drawings, in which:

FIG. 1 is a conceptual diagram of an example computing device that may reduce writes in a journaling file system;

FIG. 2 is another conceptual diagram of an example computing device that may reduce writes in a journaling file system;

FIG. 3 is a flowchart of an example method for reducing writes in a journaling file system;

FIG. 4 is a flowchart of an example method for reducing writes in a journaling file system;

FIG. 5 is a block diagram of an example system that may reduce writes in a journaling file system; and

FIG. 6 is a block diagram of an example system that may reduce writes in a journaling file system;

### DETAILED DESCRIPTION

A computing device may comprise a processor, such as a central processing unit (CPU). The CPU may execute an operating system (OS). The OS stores data on one or more storage devices using a file system. The file system defines an organization and method of writing data to the storage device so that the OS can reliably read from, and write data to the one or more storage devices.

Most modern file systems implement file system journaling. In a file system that implements file system journaling (a journaling file system), when the OS receives a request to modify the file system (i.e. a write request), the OS writes an entry to a journal of the file system comprising the operations that need to be performed for the operation to fully complete. After the journal entry has been written, the OS executes the write operation by replaying the write stored in the journal entry. Thus, each journal entry is associated with one or more operations that have not yet committed to the file system.

Once the operations specified in the journal entry have successfully been committed to the file system, the OS deletes the associated journal entry. Journaling file systems are useful in the event of a power failure, hardware failure, or system crash. In such events, a write operation, which may comprise multiple sub-operations, may not fully complete. That is, some, but not all of the operations comprising the write operation may complete. A write operation that does not fully complete may leave the file system in a corrupt state.

With a journaling file system, if the OS detects that a write was in-progress, but did not fully complete, the OS re-attempts the write by reading the journal entry associated with the incomplete writes. Based on the data stored in the journal entry, the OS replays the operations indicated by the journal entry to complete the write. In this manner, a journaling file system may fix the issue of incomplete writes corrupting the file system by enabling the OS to replay the incomplete write based on the journal entry associated with the write.

A journaling file system may create a journal entry for each pending write operation. Thus, a downside to file system journaling is that each write operation that causes the file system to write a journal entry incurs additional write overhead. More particularly, a journaling file system may incur twice as many writes (one write for creating a journal entry, and another write when the operations in the journal entry are replayed to actually write data to the file system) as compared a non-journaling file system.

The techniques of this disclosure enable an operating system to reduce the amount of writes to a file system, thereby improving the performance of the file system. More particularly, an OS as described herein may determine when there are multiple pending writes to a same page of the file system. The OS may determine whether there are multiple writes pending to a same page based on generation counters stored in the file system journal and in the file system page.

The generation counters may indicate a number of writes that are pending, or have committed to the page. If the OS determines that the generation counter value stored in the journal entry for the page differs from the generation counter stored in the page, the OS determines that additional writes are pending for the page, and therefore, that the results of any earlier-pending writes will be overwritten and can therefore be skipped. Skipping execution of the write operations increases file system write performance because fewer replays of writes from a journal entry will occur when there are multiple writes pending for a particular page.

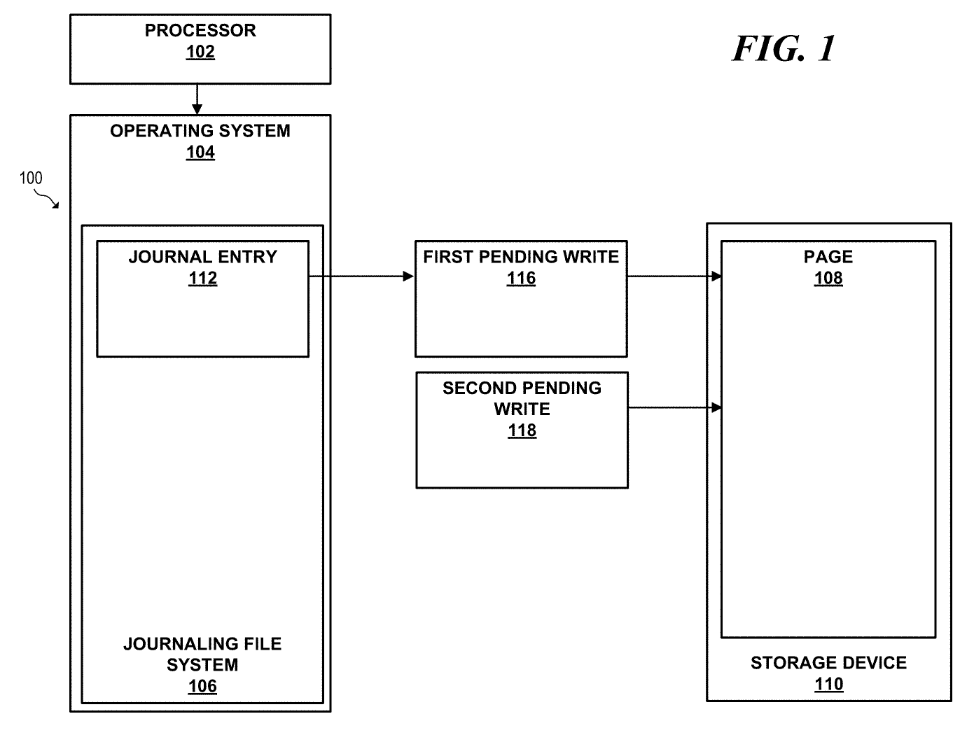

FIG. 1 is a conceptual diagram of an example computing device that may reduce writes in a journaling file system. Computing device 100 is illustrated in FIG. 1. Computing device 100 comprises a processor 102, and a storage device 110. Processor 102 may comprise a virtual processor, and/or one or more of: a central processing unit (CPU), digital signal processor (DSP), application-specific integrated circuit (ASIC), field programmable gate array (FPGA), or the like. Processor 102 executes operating system (OS) 104. In various examples, OS 104 comprises a journaling file system 106.

Journaling file system 106 may comprise any file system that stores journal entries associated with an operation for modifying data stored in journaling file system 106, and that replays each entry to execute the modifying operation. In various examples, journaling file system 106 may execute in user space, or as part of an operating system kernel. In some examples, journaling file system 106 may comprise a package or a module of OS 104. In some examples, journaling file system 106 may comprise a virtual file system, which may be associated with one or more virtual machines.

Storage device 110 is illustrated as a single storage device for the purposes of example. However, in some examples, storage device 110 may comprise multiple storage devices, a storage array, storage area network (SAN), one or more virtual storage devices, or any combination thereof. In some examples, storage device 110 may comprise a plurality of blocks. Each block may comprise a logically addressable unit of storage device 110 to which data can be written. Journaling file system 114 may write data to a single block, or to a plurality of blocks. A plurality of blocks is referred to herein as a page. Page 108 is an example of a page. It should be understood that storage device 110 comprises a plurality of pages.

OS 104 may receive a request to write data to a page of data, e.g. page 108, of storage device 110. Responsive to receiving a write request, OS 104 passes the write request to journaling file system 106. Responsive to journaling file system 106 receiving a write request, journaling file system 106 may create a journal entry associated with the write request. In the event that the write request does not complete, OS 104 may replay the write request from the journal entry to successfully complete the write, as described above.

In the example of FIG. 1, journaling file system 106 has received a first write request, and has written a journal entry 112. Journal entry 112 is associated with first pending write 116. First pending write 116 is a write operation that has not executed. First pending write 116, when executed, will write to page 108.

Journaling file system 106 may receive a second write request for page 108. Journaling file system 106 may create a second journal entry (not pictured) corresponding to the second write request responsive to receiving the second write request. OS 104 may determine that the first write request and the second write request are bound for the same page 108 based on an address indicated by the write request. The journal entry may indicate the data to be written to page 108.

As will be described herein in greater detail, journaling file system 106 may determine based, based on data stored in journal entry 112, and data stored in page 108, that second pending write 118 will occur after first pending write 116. Based on the determination that second pending write 118 will execute after first pending write 116, OS 104 may determine that second pending write 118 will overwrite the data stored in page 108 and that OS 104 may skip execution of first pending write 116.

Thus, computing device 100 represents an example computing device in which processor 102 executes OS 104. Processor 102 determines, based on page 108 of journaling file system 106 and corresponding journal entry 112 associated with first pending write 116, whether a second pending write 118 is pending for page 108, wherein the second pending write 118 will occur after first pending write 116. Responsive to determining that second pending write 118 will occur after first pending write 116, processor 102 may skip execution of first pending write 116.

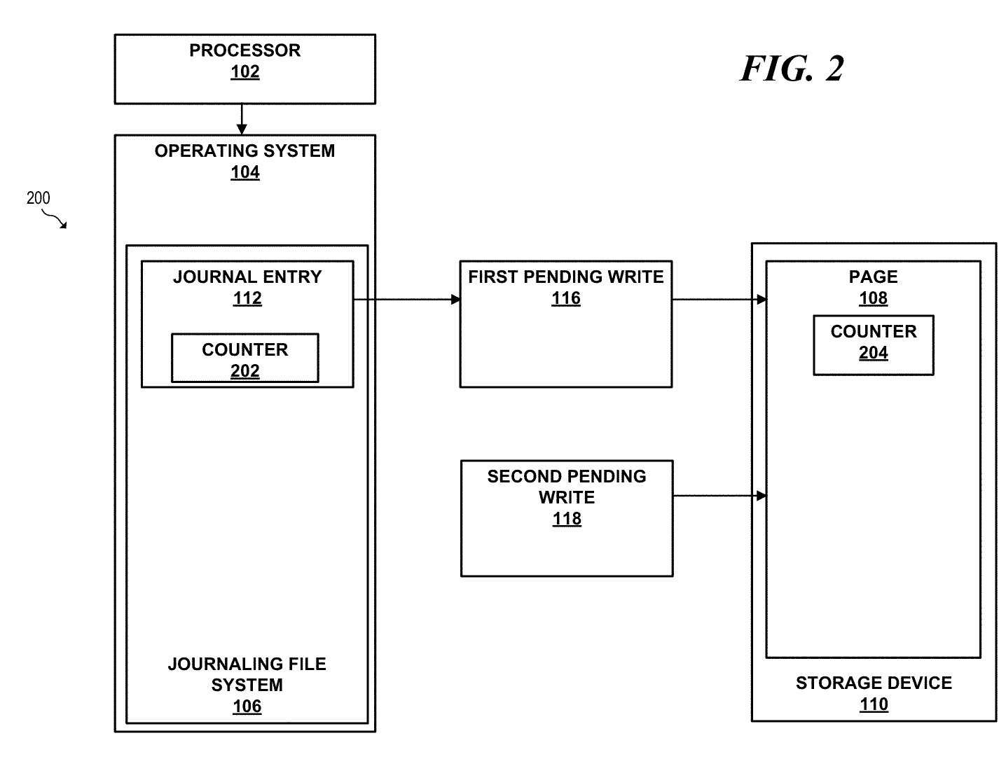

FIG. 2 is another conceptual diagram of an example computing device that may reduce journaling writes. FIG. 2 illustrates a computing device 200. In various examples, computing device 200 may be similar to computing system 100 (FIG. 1).

In the example of FIG. 2, journaling file system 106 stores a counter 202 in journal entry 112. Journaling file system 106 also stores a second counter 204 in page 108. In various examples, counters 202, and 204 may comprise generation counters. The value of the generation counter may indicate how many times page 108 has been modified, or a number of pending writes for page 108.

As described responsive to receiving a write request (e.g. first pending write 116), journaling file system 106 may create a journal entry, e.g. journal entry 112. Each journal entry may comprise a counter, e.g. counter 202. In some examples, counter 202 may indicate a number of writes pending to page 108. In various examples, counter 202 may comprise a generation counter. The generation counter may indicate how many times the page has been modified or a number of writes pending for the page.

OS may store a copy of page 108 in memory in some examples. Before creating a journal entry for a write operation, e.g. journal I entry 112 for first pending write 116, journaling file system 106 reads a value of counter 204 from the in-memory copy of page 108. File system 106 increments counter 202 and counter 204 to indicate that first pending write 116 will modify page 108.

In the example of FIG. 2, journaling file system 106 may receive a second pending write 118 that is associated with page 108. Based on the received second write, journaling file system 106 creates an associated journal entry (not pictured). In this example, second pending write 118 occurs after first pending write 116. Thus, second pending write 118 will overwrite the contents of page 108 when executed. Because the changes made in first pending write 116 will be overwritten, OS 104 determines that first pending write 116 unnecessary.

During the creation of the second journal entry associated with second pending write 118, journaling file system 106 increments counter 204, which is stored in the in-memory copy of page 108, as well as the counter stored the second journal entry associated with second pending write 118.

In this example, after journaling file system 106 has incremented counter 204 responsive to receiving the second write request, the value of counter 202 associated with first pending write operation 116 will be less than the value of counter 204. The value of the counter stored in the second journal entry associated with second pending write 118 will be equal to the value of counter 204.

When file system 106 reads a journal entry to replay a pending write operation, OS 104 compares the value of the counter stored in the journal entry with the counter stored in the in-memory copy of the page associated the journal entry. In the example of FIG. 2, OS 104 compares the values of the counter stored in the journal entry (e.g. counter 202) for the write and the counter of the page 108, i.e. counter 204. If OS 104 determines that the values of counter 202 and counter 204 are equal, OS 104 allows the pending write, e.g. pending write 116, to execute. However, if counter 202 and counter 204 are not equal as described in the above case where second pending write 118 has incremented counter 204 and second pending write 118 occurs after first pending write 116, OS 104 skips the execution of the earlier pending write, i.e. first pending write 116. By skipping the execution of the earlier pending write, the techniques of this disclosure reduce the overall number of the writes to page 108, thereby improving write throughput to page 108 and to storage device 110.

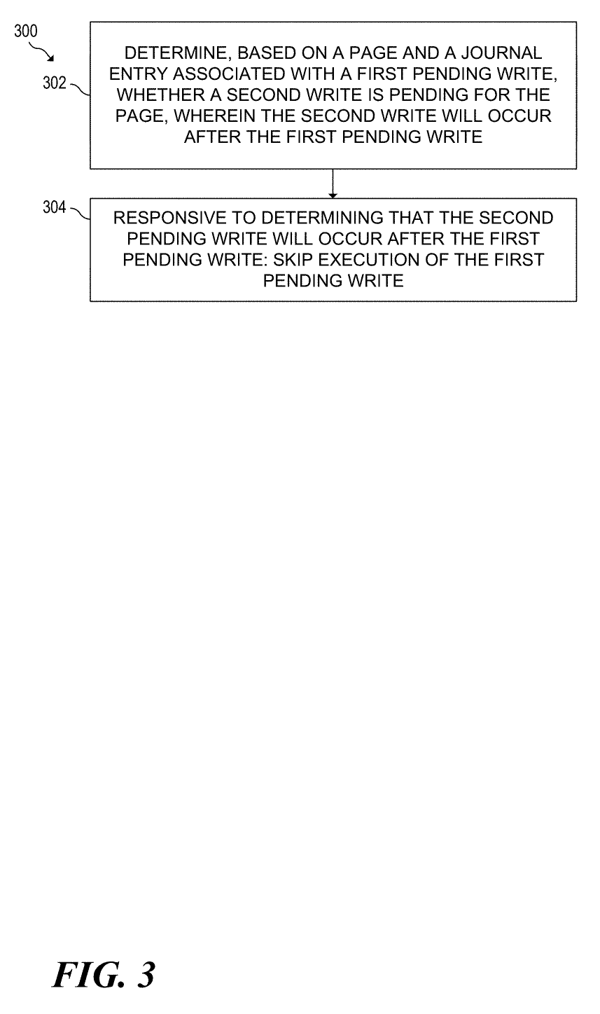

FIG. 3 is a flowchart of an example method for reducing journaling writes. FIG. 3 illustrates method 300. Method 300 may be described below as being executed or performed by a system, for example, computing system 100 (FIG. 1) or computing device 200 (FIG. 2).

In various examples, method 300 may be performed by hardware, software, firmware, or any combination thereof. Other suitable systems and/or computing devices may be used as well. Method 300 may be implemented in the form of executable instructions stored on at least one machine-readable storage medium of the system and executed by at least one processor of the system. Alternatively or in addition, method 300 may be implemented in the form of electronic circuitry (e.g., hardware). In alternate examples of the present disclosure, one or more blocks of method 300 may be executed substantially concurrently or in a different order than shown in FIG. 3. In alternate examples of the present disclosure, method 300 may include more or fewer blocks than are shown in FIG. 3. In some examples, one or more of the blocks of method 300 may, at certain times, be ongoing and/or may repeat.

Method 300 may start at block 302 at which point processor 102 may cause operating system 104 to determine based on a page (e.g. page 108) of a journaling file system (e.g. journaling file system 106) and a journal entry (e.g. journal entry 112) of the file system associated with a first pending write (e.g. first pending write 166), whether a second write (e.g. second pending write 118) is pending for the page, wherein the second write will occur after the first pending write (302).

At block 304, responsive to determining that second pending write 118 will occur after first pending write 116: OS 104 may skip execution of first pending write 116.

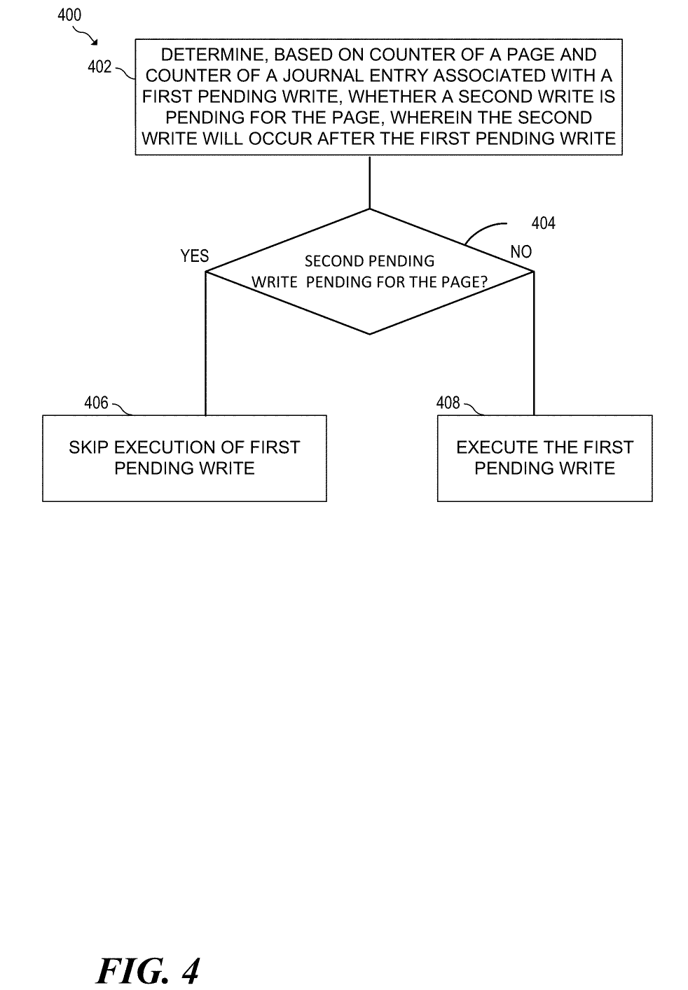

FIG. 4 is a flowchart of an example method for performing staging of write requests. FIG. 4 illustrates method 400. Method 400 may be described below as being executed or performed by a system, for example, computing system 100 (FIG. 1) or computing device 200 (FIG. 2). Other suitable systems and/or computing devices may be used as well. Method 400 may be implemented in the form of executable instructions stored on at least one machine-readable storage medium of the system and executed by at least one processor of the system. Method 400 may be performed by hardware, software, firmware, or any combination thereof.

Alternatively or in addition, method 400 may be implemented in the form of electronic circuitry (e.g., hardware). In alternate examples of the present disclosure, one or more blocks of method 400 may be executed substantially concurrently or in a different order than shown in FIG. 4. In alternate examples of the present disclosure, method 400 may include more or fewer blocks than are shown in FIG. 4. In some examples, one or more of the blocks of method 400 may, at certain times, be ongoing and/or may repeat.

In various examples, method 400 may start at block 402, at which block processor 102 may cause operating system 104 to determine based on a counter (e.g. counter 204) stored in a page (e.g. page 108) of a journaling file system (e.g. journaling file system 106) and a counter (e.g. counter 202) stored in a corresponding journal entry (e.g. journal entry 112) of the file system associated with a first pending write (e.g. first pending write 116), whether a second pending write (e.g. second pending write 118) will occur after the first pending write. In various examples counters 202 and 204 may comprise generation counters. The generation counters may indicate a number of writes that are pending for the page.

At decision block 404, OS 104 may determine whether the second write is pending for the block, wherein the second pending will occur after the first pending write. If OS 104 determines that the second write is not pending for the page (“NO” branch of decision block 404), OS 104 may execute block 408. Otherwise, (“YES” block of decision branch 404), OS 104 may execute block 406. At block 406, OS 104 may skip execution of the first pending write (e.g. first pending write 116). At block 408, OS 104 may execute the first pending write. In some examples, to determine whether the second pending write is pending for the page, OS 104 may determine whether the second pending write will overwrite data from the first pending write.

In some examples, to determine whether the second pending write is pending for the page, OS 104 may compare the values of the counter of the journal entry (e.g. counter 202), and the value of the counter of the page (e.g. counter 204). OS 104 may execute block 406, and skip execution of the write responsive to determining that counters 202 and 204 are not equal. OS 104 may execute block 404 and execute the first pending write (e.g. first pending write 116) responsive to determining that counters 202 and 204 are equal.

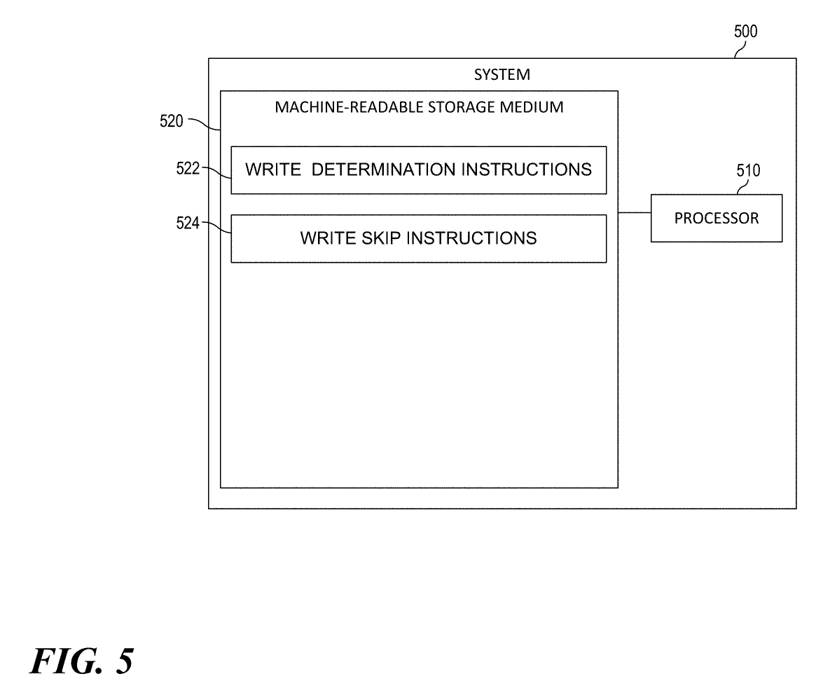

FIG. 5 is a block diagram of an example system for reducing writes in a journaling file system. In the example of FIG. 5, system 500 includes a processor 510 and a machine-readable storage medium 520. Although the following descriptions refer to a single processor and a single machine-readable storage medium, the descriptions may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 510 may be one or more central processing units (CPUs), microprocessors, and/or other hardware devices suitable for retrieval and execution of instructions stored in machine-readable storage medium 520. In the particular example shown in FIG. 5, processor 510 may fetch, decode, and execute instructions 522, 524, 526 to reduce writes in a journaling file system of computing system 500. As an alternative or in addition to retrieving and executing instructions, processor 510 may include one or more electronic circuits comprising a number of electronic components for performing the functionality of one or more of the instructions in machine-readable storage medium 520. With respect to the executable instruction representations (e.g., boxes) described and shown herein, it should be understood that part or all of the executable instructions and/or electronic circuits included within one box may, in alternate examples, be included in a different box shown in the figures or in a different box not shown.

Machine-readable storage medium 520 may be any electronic, magnetic, optical, or other physical storage device that stores executable instructions. Thus, machine-readable storage medium 520 may be, for example, Random Access Memory (RAM), an Electrically-Erasable Programmable Read-Only Memory (EEPROM), a storage drive, an optical disc, and the like. Machine-readable storage medium 520 may be disposed within system 500, as shown in FIG. 5. In this situation, the executable instructions may be “installed” on the system 500. Alternatively, machine-readable storage medium 520 may be a portable, external or remote storage medium, for example, that allows system 500 to download the instructions from the portable/external/remote storage medium. As described herein, machine-readable storage medium 520 may be encoded with executable instructions for reducing writes in a journaling file system.

Referring to FIG. 5, write determination instructions 522, when executed by a processor (e.g., 510), may cause system 500 to determine, based on a page of a journaling file system and a corresponding journal entry of the file system, whether a second write is pending for the page, wherein the second pending write will occur after the first pending write.

Responsive to determining that the second pending write will occur after the first pending write, processor 510 may execute write skip instructions 524. Write skip instructions 524, when executed by a processor (e.g., 510), may cause system 500 to skip execution of the first pending write.

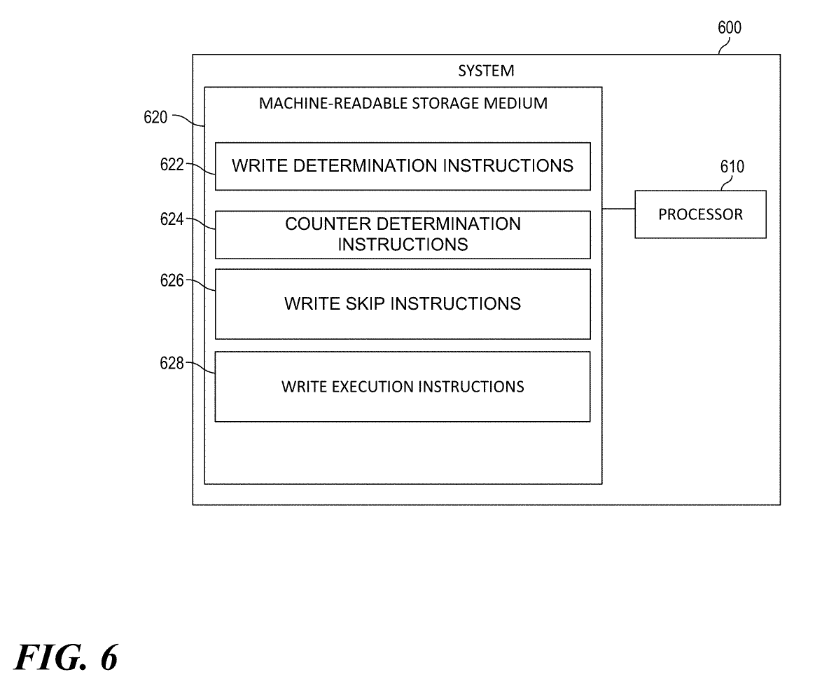

FIG. 6 is a block diagram of an example system for reducing writes in a journaling file system. In the example of FIG. 6, system 600 includes a processor 610 and a machine-readable storage medium 620. Although the following descriptions refer to a single processor and a single machine-readable storage medium, the descriptions may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 610 may be one or more central processing units (CPUs), microprocessors, and/or other hardware devices suitable for retrieval and execution of instructions stored in machine-readable storage medium 620. In the particular example shown in FIG. 6, processor 610 may fetch, decode, and execute instructions 622, 624, 626 to reduce writes in a journaling file system of computing system 600. As an alternative or in addition to retrieving and executing instructions, processor 610 may include one or more electronic circuits comprising a number of electronic components for performing the functionality of one or more of the instructions in machine-readable storage medium 620. With respect to the executable instruction representations (e.g., boxes) described and shown herein, it should be understood that part or all of the executable instructions and/or electronic circuits included within one box may, in alternate examples, be included in a different box shown in the figures or in a different box not shown.

Machine-readable storage medium 620 may be any electronic, magnetic, optical, or other physical storage device that stores executable instructions. Thus, machine-readable storage medium 620 may be, for example, Random Access Memory (RAM), an Electrically-Erasable Programmable Read-Only Memory (EEPROM), a storage drive, an optical disc, and the like. Machine-readable storage medium 620 may be disposed within system 600, as shown in FIG. 6. In this situation, the executable instructions may be “installed” on the system 600. Alternatively, machine-readable storage medium 620 may be a portable, external or remote storage medium, for example, that allows system 600 to download the instructions from the portable/external/remote storage medium. As described herein, machine-readable storage medium 620 may be encoded with executable instructions for reducing writes in a journaling file system.

Referring to FIG. 6, write determination instructions 622, when executed by a processor (e.g., 610), may cause system 600 to determine, based on a page of a journaling file system and a corresponding journal entry of the file system, whether a second write is pending for the page, wherein the second pending write overwrite data of the first pending write.

At block 624 processor 610 may execute counter determination instructions 624, which when executed, cause processor 610 to determine whether the second write is pending for the page and will occur after the first pending write based on a generation counter of the journal entry and a generation counter of the page. The generation counter of the journal entry and the generation counter of the page may indicate a number of writes that are pending for the page. In some examples, the generation counter may indicate a number of writes that will commit to the page.

Responsive to determining that the second pending write will occur after the first pending write (e.g. based on the counters), processor 610 may execute write skip instructions 626. Write skip instructions 626, when executed by a processor (e.g., 610), may cause system 600 to skip execution of the first pending write responsive to determining that the generation counter of the journal entry and the generation counter of the page are not equal.

Responsive to determining that the second pending write will occur after the first pending write, processor 610 may execute write execution instructions 628. Write execution instructions 628, when executed by a processor (e.g., 610), may cause system 600 to execute the first pending write.

1. A method comprising:
determining, based on a counter of a page of a journaling file system and a counter of a journal entry of the file system associated with a first pending write, whether a second write is pending for the page, wherein the second write will occur after the first pending write; and
responsive to determining that the second pending write will occur after the first pending write:
skipping execution of the first pending write.

2. The method of claim 1, wherein the counter of the journal entry and the counter of the page comprise generation counters.

3. The method of claim 2,
wherein the generation counters indicate numbers of writes that are pending for the page.

4. The method of claim 1, wherein the wherein the counter of the journal entry and the counter of the page indicate a total number of writes that will be committed to the page.

5. The method of claim 1, comprising:
determining whether the counter of the journal entry and the counter of the page are equal; and
skipping the execution of the write responsive to determining that the counter of the journal entry and the counter of the page are not equal.

6. The method of claim 1, comprising:
responsive to determining that the second pending write is not pending for the page:
executing the pending write.

7. The method of claim 1, wherein determining whether the second write is pending for the page further comprises:
determining whether the second pending write will overwrite data from the first pending write.

8. A device comprising:
a memory; and
a processor to execute an operating system comprising a journaling file system, the processor to:
determine, based on a page of a journaling file system and a journal entry of the file system associated with a first pending write, whether a second write is pending for the page, wherein the second pending write will occur after the first pending write; and
responsive to determining that the second pending write will occur after the first pending write:
skipping execution the first pending write.

9. The device of claim 8, wherein to determine that the second pending write will occur after the first pending write is based on a counter of the journal entry and a counter of the page.

10. The device of claim 9, wherein the counter of the journal entry and the counter of the page comprise generation counters,
wherein the generation counters indicate a number of writes that are pending for the page.

11. The device of claim 9,
wherein the counter of the journal entry and the counter of the page indicate a total number of writes that will be committed to the page.

12. The device of claim 9, the processor to:
determine whether the counter of the journal entry and the counter of the page are equal; and
skip execution of the first pending write responsive to determining that the counter of the journal entry and the counter of the page are not equal.

13. The device of claim 8, the processor to:
responsive to determining that the second pending write is not pending for the page:
execute the first pending write.

14. The device of claim 8, wherein to determine whether the second write will occur after the first pending write, the processor to:
determine whether the second pending write will overwrite data from the first pending write.

15. A non-transitory machine-readable storage medium encoded with instructions, the instructions that, when executed, cause a processor to:
determine, based on a page of a journaling file system and a corresponding journal entry of the file system, whether a second write is pending for the page, wherein the second pending write will overwrite data from the first pending write;
responsive to determining that the second pending write will overwrite data the first pending write:
skip execution of the first pending write; and

16. The non-transitory machine-readable storage medium of claim 15, comprising instructions that, when executed, cause the processor to:
wherein the counter of the journal entry and the counter of the page comprise generation counters,
wherein the generation counters indicate a number of writes that are pending for the page.

17. The non-transitory computer-readable storage medium of claim 15
wherein the counter of the journal entry and the counter of the page indicate a total number of writes that will be committed to the page.

18. The non-transitory computer-readable storage medium of claim 15 comprising instructions that, when executed, cause the processor to:
determine whether the counter of the journal entry and the counter of the page are equal; and
skip the execution of the write responsive to determining that the counter of the journal entry and the counter of the page are not equal.

19. The non-transitory machine-readable storage medium of claim 15 comprising instructions that, when executed, cause the processor to:
responsive to determining that the second pending write is not pending for the page:
execute the first pending write.
